(19) United States
(12) Patent Application Publication
(10) Pub. No.: US 2019/0202985 A1
(43) Pub. Date: Jul. 4, 2019

(54) CAPROLACTAM FORMULATIONS

(71) Applicant: BASF SE, Ludwigshafen am Rhein (DE)

(72) Inventor: Philippe Desbois, Edingen-Neckarhausen (DE)

(21) Appl. No.: 15/572,536

(22) PCT Filed: May 10, 2016
(86) PCT No.: PCT/EP2016/060457

§ 371 Date: Feb. 12, 2018

(30) Foreign Application Priority Data
May 12, 2015 (EP) 15167407.4
Jan. 29, 2016 (EP) 16153427.6

(51) Int. Cl. C08G 69/18; C08K 7/14; C08J 3/22

(52) U.S. Cl. CPC C08G 69/18; C08J 2377/02; C08J 3/22; C08K 7/14

(57) ABSTRACT

A process for the production of a masterbatch (M) which includes at least one lactam and at least one fiber material is provided herein. Also described herein is the masterbatch (M) and a polymerizable two-component system (pS), as well as a process for the production of a polyamide (P), the use of the masterbatch (M) for the production of the polyamide (P), and the polyamide (P). A molding made of the polyamide (P) is also described.

The present invention relates to a process for the production of a masterbatch (M) which comprises at least one lactam and at least one fiber material. The present invention also relates to the masterbatch (M) and to a polymerizable two-component system (pS). The present invention also relates to a process for the production of a polyamide (P), to the use of the masterbatch (M) for the production of the polyamide (P), and also to the polyamide (P). The invention further relates to a molding made of the polyamide (P).

Polyamides are generally semicrystalline polymers which are of particular industrial importance because they feature very good mechanical properties. In particular, they have high strength, stiffness, and toughness, good chemicals resistance, and also high abrasion resistance and tracking resistance. These properties are particularly important for the production of injection moldings. High toughness is particularly important for the use of polyamides as packaging films. The properties of polyamides lead to their use in industry for the production of textiles such as fishing lines, climbing ropes, and carpeting. Polyamides are also used for the production of wall plugs, screws and bolts, and cable binders. Polyamides are also used as adhesives, coatings, and coating materials.

Polyamide moldings have increasingly been used in recent years as materials in their own right and as replacement for metallic materials, for example in automobile construction, and are capable of replacing not only parts within the power train but also metal bodywork parts. In particular, fiber-reinforced polyamide moldings are used for this purpose. Various processes are described in the prior art for the production of fiber-reinforced polyamide moldings: by way of example, a mold in which the molding is to be produced can comprise a fiber material, and the corresponding monomers for the production of the polyamide can be charged to the mold, whereupon the polymerization of the monomers is initiated in situ. This generally requires only heating to a temperature that is above the melting point of the monomers and not above the melting point of the polyamide to be produced.

Another possible method for the production of polyamide moldings comprising fiber reinforcement is described by way of example in WO 2014/086757. Here, a polymerizable composition comprising a lactam, a catalyst, and an activator is applied in the form of a free-flowing solid to a fiber material, and said fiber material is then treated at elevated pressure and at a temperature at which the solid polymerizable composition is capable of flow, and finally the fiber material is cooled. The fiber material can then be subjected to a forming process. In the course of this, the lactam polymerizes.

The resultant polyamide moldings have good mechanical stability.

EP 2 789 641 describes a process for the production of compositions which comprise a lactam and/or lactone, a catalyst, and an activator. They are produced by mixing the components, for example in an extruder. The process described in EP 2 789 641 gives good results in the production of these compositions. The compositions can also comprise fillers and/or reinforcing materials. If these fillers and/or reinforcing materials are added within the extruder during the mixing of the other components, however, inhomogeneous mixtures are often obtained which have a tendency toward formation of clumps, and sometimes cause blocking of the die.

US 2010/0286343 describes a process for producing glassfiber-reinforced polyamides. Here, a glassfiber material is mixed with a lactam monomer and a polymerization catalyst and heated in an extruder so that the lactam polymerizes. This gives a glassfiber-reinforced polyamide. However, US 2010/0286343 does not describe any method for the production of a masterbatch in which the lactam is present in unpolymerized form.

EP 0 459 199 describes the production of lactam melts with relatively high viscosity. The lactam melts comprise a lactam and optionally fillers and reinforcing materials. For the production process, they are homogenized with stirring. It is disadvantageous that these lactam melts cannot be produced, or are difficult to produce, in an extruder because inhomogeneous mixtures are often obtained which have a tendency toward formation of clumps and sometimes block the die.

There is therefore a need for further processes for the production of moldings made of a polyamide (P) with good mechanical stability, and also a need for polymerizable two-component systems (pS) which permit production of these moldings, and also a need for a masterbatch (M) which can be used in a polymerizable two-component system (pS), and processes for the production of the corresponding masterbatch (M).

The object underlying the present invention is therefore the provision of a process for the production of a masterbatch (M) which permits production of moldings made of a polyamide (P).

Said object is achieved via a process for the production of a masterbatch (M) which comprises the following components:

(A) at least one lactam and

(D) at least one fiber material,

which comprises compounding components (A) and (D) in an extruder with shear rate at least 500 s⁻¹.

The masterbatch (M) produced in the invention can be stored, transported, and handled, and can also be used at a subsequent juncture for the production of a polyamide (P).

The polyamides (P) produced with the masterbatch (M) produced in the invention, in particular those produced with the polymerizable two-component system (pS) of the invention, and also moldings made of said polyamides, moreover exhibit a particularly uniform distribution of the at least one fiber material (component (D)), and this provides particularly good mechanical stability and reinforcement of the molding.

The polymerizable two-component system (pS) of the invention, comprising the masterbatch (M), is also in particular suitable for injection-molding processes where the nozzles, in particular those through which the masterbatch (M) is passed, surprisingly do not become blocked during the injection-molding process, despite the at least one fiber material (component (D)) comprised in the masterbatch (M). Polymerization of the polymerizable two-component system (pS) is moreover particularly complete, and this provides a low residual monomer content in the resultant polyamide (P).

The process of the invention is explained in more detail below.

The components (A)—at least one lactam and (D)—at least one fiber material are compounded in the process of the invention in an extruder at shear rate at least 500 s⁻¹.

For the purposes of the present invention, “compounding” means the mixing of components (A) and (D).

Components (A) and (D) can be compounded in the extruder by any of the methods known to the person skilled in the art. By way of example, components (A) and (D) can be introduced together into the extruder and compounded therein. It is equally possible, and in the invention it is preferable, that component (A) is first introduced into the extruder and then component (D) is introduced. Components (A) and (D) are then compounded.

It is most preferable in the invention that a first portion of component (A) is first introduced into the extruder, and that component (D) is then introduced, and that component (D) and the first portion of component (A) are compounded to give a first mixture (M1) comprising component (D) and the first portion of component (A). A second portion of component (A) is then introduced into the extruder, and the first mixture (M1) and the second portion of component (A) are compounded to give the masterbatch (M).

The compounding can take place at any desired temperature, with the precondition that component (A) is liquid under the conditions prevailing in the extruder. By way of example, the compounding can be carried out with a jacket temperature of the extruder in the range from 20 to 220° C., preferably with a jacket temperature of the extruder in the range from 30 to 180° C., and with particular preference with a jacket temperature of the extruder in the range from 35 to 170° C.

For the purposes of the present invention, “liquid” means that component (A) can be conveyed within the extruder.

“Jacket temperature of the extruder” means the temperature of the extruder jacket. The jacket temperature of the extruder is therefore the temperature of the external wall of the extruder barrel.

The jacket temperature of the extruder can be higher than the temperature of the components in the extruder; it is likewise possible that the jacket temperature of the extruder is lower than the temperature of the components in the extruder. By way of example, it is possible that the jacket temperature of the extruder is initially higher than the temperature of the components in the extruder when the components are being heated. If the components in the extruder are being cooled, it is possible that the jacket temperature of the extruder is lower than the temperature of the components in the extruder.

The extruder is usually heated or cooled during the process of the invention. The heating and cooling of the extruder can be achieved by any of the methods known to the person skilled in the art. The extruder is usually heated by the frictional heat liberated during the compounding of components (A) and (D). The extruder can also be heated externally, for example by circulation of a liquid within the extruder barrel. This liquid can also be used for the cooling of the extruder. These processes are known per se to the person skilled in the art.

The masterbatch (M) is usually removed from the extruder after the compounding of components (A) and (D). The masterbatch (M) can be removed from the extruder by any of the methods known to the person skilled in the art, for example via a die. It is preferable that the masterbatch (M) is pelletized to give a pelletized masterbatch (gM).

Processes for the pelletization of the masterbatch (M) are known per se to the person skilled in the art. By way of example, the masterbatch (M) can be cooled on a conveyor belt and then pelletized. It is moreover possible that on removal of the masterbatch (M) from the extruder by way of example through a die it is obtained directly in the form of pellets, as pelletized masterbatch (gM). In this embodiment there is no requirement for any additional pelletization. This embodiment is preferred.

The shear rate of the extruder in the invention is at least 500 s⁻¹, preferably at least 800 s⁻¹, and with particular preference at least 1000 s⁻¹.

The shear rate of the extruder is by way of example in the range from 500 to 25 000 s⁻¹, preferably in the range from 800 to 25 000 s⁻¹, and with particular preference in the range from 1000 to 25 000 s⁻¹.

The shear rate of the extruder can be calculated by using the following formula:

S=(π·d·N)/Δ

where
S is the shear rate,
d is the diameter of the extruder screw,
N is the rotation rate of the extruder screw, and
Δ is the width of the gap between the exterior wall of the screw and the internal wall of the extruder.

The diameter (d) of the screw is usually in the range from 10 to 300 mm, preferably in the range from 20 to 200 mm, and with particular preference in the range from 50 to 100 mm.

The rotation rate (N) of the screw is by way of example in the range from 50 to 2000 rpm (revolutions per minute), preferably in the range from 80 to 1500 rpm, and with particular preference in the range from 100 to 1200 rpm.

The width (Δ) of the gap is usually in the range from 10 to 500 μm, preferably in the range from 50 to 250 μm, and with particular preference in the range from 100 to 200 μm.

The shear stress (a) exerted by the extruder on the components comprised is obtained from the product of the shear rate (S) of the extruder and the viscosity (η) of the components comprised in the extruder:

σ=S·η

The viscosity (η) of the components comprised in the extruder is usually in the range from 2 to 1000 mPas, preferably in the range from 5 to 500 mPas, and with particular preference in the range from 10 to 300 mPas, measured by a shear-stress-controlled rotary viscometer at shear rate 100 s⁻¹ and temperature 100° C.

The shear stress (σ) is therefore by way of example in the range from 2.5 to 12 500 Pa, preferably in the range from 4 to 12 500 Pa, and with particular preference in the range from 5 to 12 500 Pa.

Suitable extruders are any of the extruders known to the person skilled in the art, for example single-screw extruders or twin-screw extruders. Preference is given in the invention to twin-screw extruders. Single-screw extruders and twin-screw extruders are known to the person skilled in the art.

The extruder preferably comprises at least two sections.

With particular preference the extruder comprises at least the following sections:

(I) a first section,

(II) a second section, and

(III) a third section.

The individual sections of the extruder differ in the concentration of components (A) and (D), and also of the optionally comprised components (B), (C), and (E) comprised in said sections in the extruder.

The present invention therefore also provides a process in which the concentration of components (A) and (D) in the first section (I) of the extruder differs from the concentration of components (A) and (D) in the second section (II) and in the third section (III) of the extruder, and in which the concentration of components (A) and (D) in the second section (II) of the extruder differs from the concentration of components (A) and (D) in the third section (III) of the extruder.

The sections can moreover differ by way of example in the temperature ranges prevailing in the respective sections of the extruder, and also optionally in the pressure ranges prevailing in the respective sections of the extruder.

By way of example, a first temperature (T1) can prevail in the first section (I) of the extruder. For the purposes of the present invention, “a first temperature (T1)” means that there can be, in the first section (I), precisely one first temperature (T1) prevailing which is equal (constant) across the entire first section (I); equally, it is possible that there are two or more first temperatures (T1) prevailing in the extruder. If there are two or more first temperatures (T1) prevailing in the first section (I) of the extruder, it is possible that there is a temperature gradient prevailing in the first section (I), and that the first temperature (T1) continuously increases or decreases. Equally, it is possible that regions of constant first temperature (T1) alternate with regions in which the first temperature continuously increases or decreases. It is moreover also possible that the temperature changes suddenly between regions of constant first temperature (T1).

The first temperature (T1) is preferably in the range from 20 to 70° C., particularly preferably in the range from 25 to 50° C., and with particular preference in the range from 30 to 40° C.

A second temperature (T2) can prevail in the second section (II) of the extruder. For the purposes of the present invention, “a second temperature (T2)” means that there can be, in the second section (II) of the extruder, precisely one second temperature (T2) prevailing which is equal (constant) across the entire second section (II); equally, it is possible that there are two or more second temperatures (T2) prevailing in the second section (II) of the extruder. If there are two or more second temperatures (T2) prevailing in the second section (II) of the extruder, it is possible that there is a temperature gradient prevailing in the second section (II), and that the second temperature (T2) continuously increases or decreases. Equally, it is possible that regions of constant second temperature (T2) alternate with regions in which the second temperature (T2) continuously increases or decreases. It is moreover also possible that the temperature changes suddenly between regions of constant second temperature (T2).

The second temperature (T2) is preferably in the range from 105 to 220° C., particularly preferably in the range from 110 to 180° C., and with particular preference in the range from 115 to 175° C.

In the third section (III) of the extruder by way of example there is a third temperature (T3) prevailing. For the purposes of the present invention, “a third temperature (T3)” means that there can be, in the third section (III) of the extruder, precisely one third temperature (T3) prevailing which is equal (constant) across the entire third section (III); equally, it is possible that there are two or more third temperatures (T3) prevailing in the third section (III) of the extruder. If there are two or more third temperatures (T3) prevailing in the third section (III) of the extruder, it is possible that there is a temperature gradient prevailing in the third section (III), and that the third temperature (T3) continuously increases or decreases. Equally, it is possible that regions of constant third temperature (T3) alternate with regions in which the third temperature (T3) continuously increases or decreases. It is moreover also possible that the temperature changes suddenly between the regions of constant third temperature (T3).

The third temperature (T3) is preferably in the range from 20 to <105° C., particularly preferably in the range from 30 to 102° C., and with particular preference in the range from 35 to 100° C.

It is preferable that the second temperature (T2) differs from the first temperature (T1) and from the third temperature (T3).

The present invention therefore also provides a process in which the second temperature (T2) differs from the first temperature (T1), and in which the second temperature (T2) differs from the third temperature (T3).

It is thus preferable that the extruder comprises at least the following sections:

(I) a first section,

(II) a second section, and

(III) a third section,

where a first temperature (T1) prevails in the first section (I) of the extruder, a second temperature (T2) prevails in the second section (II), and a third temperature (T3) prevails in the third section (III), where the second temperature (T2) is in the range from 105 to 220° C.

The present invention therefore also provides a process in which the extruder comprises at least the following sections:

(I) a first section,

(II) a second section, and

(III) a third section,

where a first temperature (T1) prevails in the first section (I) of the extruder, a second temperature (T2) prevails in the second section (II), and a third temperature (T3) prevails in the third section (III), where the second temperature (T2) is in the range from 105 to 220° C.

It is moreover preferable that a first temperature (T1) in the range from 20 to 70° C. prevails in the first section (I) of the extruder and/or a third temperature (T3) in the range from 20 to <105° C. prevails in the third section (III) of the extruder.

The present invention therefore also provides a process in which a first temperature (T1) in the range from 20 to 70° C. prevails in the first section (I) of the extruder and/or a third temperature (T3) in the range from 20 to <105° C. prevails in the third section (III) of the extruder.

The expressions first temperature (T1), second temperature (T2), and third temperature (T3) respectively mean the jacket temperature of the extruder in the respective sections. The first temperature (T1) prevailing in the first section (I) of the extruder is therefore also termed first jacket temperature of the extruder. The expressions “first temperature (T1)” and “first jacket temperature” are therefore used as synonyms for the purposes of the present invention, and therefore have the same meaning. The second temperature (T2) prevailing in the second section (II) of the extruder is therefore also called second jacket temperature of the extruder. The terms “second temperature (T2)” and “second jacket temperature” are therefore used as synonyms for the purposes of the present invention, and therefore have the same meaning. The third temperature (T3) prevailing in the third section (III) of the extruder is therefore also called third jacket temperature of the extruder. The terms “third temperature (T3)” and “third jacket temperature” are therefore used as synonyms for the purposes of the present invention, and therefore have the same meaning.

The descriptions above relating to the jacket temperature of the extruder apply correspondingly to determination of the first jacket temperature, the second jacket temperature, and the third jacket temperature.

Each section of the extruder moreover comprises at least one zone.

For the purposes of the present invention, “at least one zone” means either precisely one zone or else two or more zones.

If a section of the extruder comprises precisely one zone, the section of the extruder corresponds to the zone.

The zones differ by way of example in the temperature within the zones, in the pressure within the zones, and/or in the elements comprised within the zones.

The zones can moreover differ in the length of the elements comprised.

The expression “elements comprised” means by way of example conveying elements, flow-restricting elements, mixing elements, and kneading elements. Suitable conveying elements, flow-restricting elements, mixing elements, and kneading elements which can be comprised in the extruder are known to the person skilled in the art.

Conveying elements serve for the onward transport of the components comprised within the extruder. The shear rate acting on the components in the extruder via the conveying elements is smaller than the shear rate acting on the components in the extruder via mixing elements or kneading elements. Suitable conveying elements are known to the person skilled in the art and are by way of example screw-conveying elements.

Mixing elements serve for the mixing of the individual components comprised in the extruder. The shear rate acting on the components in the extruder via the mixing elements is usually smaller than the shear rate acting on the components via kneading elements. Suitable mixing elements are known to the person skilled in the art and are by way of example toothed mixing elements or screw mixing elements.

Kneading elements likewise serve for the mixing of the individual components comprised in the extruder. At the same time, they comminute by way of example component (D). The shear rate acting on the components in the extruder via the kneading elements is usually higher than the shear rate acting on the components via mixing elements and via conveying elements. Suitable kneading elements are known to the person skilled in the art and are by way of example kneading screws or kneading blocks, for example disk kneading blocks or shoulder kneading blocks.

Flow-restricting elements are unlike conveying elements in having reverse-conveying effect, and thus restrict the flow of the components comprised in the extruder. Flow-restricting elements usually used are conveying elements mounted in such a way that their direction of conveying is opposite to the direction of transport in the extruder.

Zones comprising conveying elements are also called “conveying zones”. Zones comprising flow-restricting elements are also called “flow-restricting zones”. Zones comprising mixing elements are also called “mixing zones”, and zones comprising kneading elements are also called “kneading zones”.

In one embodiment, the extruder comprises from 1 to 20 conveying zones, from 1 to 10 flow-restricting zones, from 1 to 10 mixing zones, and from 1 to 10 kneading zones, preferably from 2 to 15 conveying zones, from 1 to 8 flow-restricting zones, from 1 to 5 mixing zones, and from 2 to 10 kneading zones, with particular preference from 5 to 13 conveying zones, from 1 to 5 flow-restricting zones, from 1 to 3 mixing zones, and from 3 to 7 kneading zones.

By way of example, the first section (I) of the extruder preferably comprises from 1 to 5 conveying zones and optionally from 1 to 3 mixing zones, particularly preferably from 1 to 3 conveying zones and optionally one mixing zone, and with particular preference precisely one conveying zone.

Equally, the second section (II) of the extruder preferably comprises from 2 to 10 kneading zones and from 1 to 10 conveying zones, preferably from 2 to 8 kneading zones and from 1 to 8 conveying zones, and with particular preference from 2 to 5 kneading zones and from 1 to 4 conveying zones.

The third section (III) of the extruder moreover preferably comprises from 1 to 5 mixing zones, from 1 to 5 kneading zones, from 2 to 10 conveying zones, and from 1 to 5 flow-restricting zones, preferably from 1 to 4 mixing zones, from 1 to 3 kneading zones, from 2 to 8 conveying zones, and from 1 to 4 flow-restricting zones, and with particular preference from 1 to 3 mixing zones, from 1 to 2 kneading zones, from 2 to 5 conveying zones, and from 1 to 3 flow-restricting zones.

The present invention therefore also provides a process in which the second section (II) of the extruder comprises from 2 to 10 kneading zones and from 1 to 10 conveying zones and/or the third section (III) of the extruder comprises from 1 to 5 mixing zones, from 1 to 5 kneading zones, from 2 to 10 conveying zones, and from 1 to 5 flow-restricting zones.

It is usual that at least one conveying zone is always followed by at least one mixing zone, or at least one kneading zone, or at least one flow-restricting zone.

It is usual that a conveying zone is always followed by precisely one mixing zone, or precisely one kneading zone, or precisely one flow-restricting zone.

It is preferable in the invention that the extruder comprises a mixing zone immediately before the point of removal of the masterbatch (M), preferably immediately before the die for removal of the masterbatch (M). It is particularly preferable that the extruder comprises a mixing zone with at least one toothed-disk element in screw configuration immediately before the point of removal of the masterbatch (M), preferably immediately before the die for removal of the masterbatch (M).

“At least one toothed-disk element” means for the purposes of the present invention either precisely one toothed-disk element or else two or more toothed-disk elements. Preference is given to two or more toothed-disk elements, and particular preference is given to from 2 to 5 toothed-disk elements.

In an embodiment preferred in the invention, components (A) and (D) are compounded by first introducing component (A) into the extruder. Component (A) can be introduced into the extruder in any of the forms known to the person skilled in the art, for example in the form of pellets or powder, or in liquid form.

If component (A) is introduced in solid form, i.e. by way of example as pellets or powder, into the extruder it is then usually first liquefied in the extruder and introduced into at least one conveying zone, preferably into precisely one conveying zone. This at least one conveying zone is preferably followed by at least one kneading zone, particularly preferably precisely one kneading zone, in which component (D) is added. The at least one kneading zone, preferably precisely one kneading zone, in which component (D) is added is usually followed by at least one further conveying zone and at least one further kneading zone, preferably from 2 to 10 kneading zones and from 1 to 10 conveying zones. These from 2 to 10 kneading zones and from 1 to 10 conveying zones preferably alternate in such a way that each kneading zone is followed by a conveying zone and each conveying zone is followed by a kneading zone. In these, component (A) is then compounded with component (D) to give the masterbatch (M).

In a preferred embodiment, a first portion of component (A) is first introduced into the extruder. The above descriptions and preferences relating to the introduction of component (A) apply correspondingly to this introduction.

Component (D) is then added in a kneading zone. This kneading zone in which component (D) is added is preferably followed by at least one conveying zone and at least one kneading zone in which the first portion of component (A) is compounded with component (D) to give a first mixture (M1), which comprises component (D) and the first portion of component (A). The above descriptions and preferences apply correspondingly to the at least one conveying zone and the at least one kneading zone.

A second portion of component (A) is then added in a further kneading zone. This kneading zone is usually followed by at least one conveying zone and at least one kneading zone, and also optionally at least one flow-restricting zone and at least one mixing zone in which the second portion of component (A) is compounded with the first mixture (M1) to give the masterbatch (M).

This embodiment is preferred. In this embodiment by way of example the first section (I) of the extruder is the section in which the extruder comprises the first portion of component (A). The second section (II) begins with the addition of component (D) into the extruder. The third section (III) begins with the addition of the second portion of component (A) into the extruder.

In the first section (I) of the extruder, the extruder therefore comprises component (A); in the second section (II) of the extruder, the extruder comprises components (A) and (D), and in the third section (III) of the extruder, the extruder comprises component (A) and component (D), but the concentration of components (A) and (D) in the third section (III) differs from the concentration of components (A) and (D) in the second section (II).

It is self-evident that when at least one of the components (B), at least one catalyst, (C), at least one activator, or (E), at least one thickener, these components being described at a later stage below, is also added in a section of the extruder, said section, and also the sections thereafter, also comprise said component.

The quantitative proportions of components (A) and (D) compounded in the extruder are usually the same as those intended to be comprised in the masterbatch (M) to be produced. By way of example, from 10 to 99% by weight of component (A) and from 1 to 90% by weight of component (D), based in each case on the sum of the percentages by weight of components (A) and (D), are compounded in the extruder.

It is preferable that from 25 to 85% by weight of component (A) and from 15 to 75% by weight of component (D), based in each case on the total of the percentages by weight of components (A) and (D), are compounded in the extruder.

It is particularly preferable that from 50 to 75% by weight of component (A) and from 25 to 50% by weight of component (D), based in each case on the total of the percentages by weight of components (A) and (D), are compounded in the extruder.

When, in a preferred embodiment of the present invention, a first portion of component (A) is first introduced into the extruder, followed by component (D) and then by a second portion of component (A), it is preferable to introduce, as first portion of component (A), from 20 to 80% of component (A) and to introduce, as second portion of component (A), from 80 to 20% of component (A), based in each case on the total quantity of component (A) introduced into the extruder. It is particularly preferable to introduce, as first portion of component (A), from 40 to 60% of component (A) and to introduce, as second portion of component (A), from 60 to 40% of component (A), based in each case on the total quantity of component (A) introduced into the extruder. If the masterbatch (M) is also intended to comprise other components, and also optionally a component (B), at least one catalyst, a component (C), at least one activator, and/or a component (E), at least one thickener, these are likewise compounded in the extruder.

Components (A), (D), and optionally (B), (C), and (E), and also, where appropriate, the other components that can be compounded in the extruder are subject to the descriptions and preferences below relating to components (A), (D), and optionally (B), (C), and (E), and also relating to the optional other components comprised in the masterbatch (M).

If the masterbatch (M) is intended to comprise a component (E), at least one thickener, it is preferable to introduce this into the extruder together with component (A), in particular with the first portion of component (A). It is self-evident that the sections of the extruder then also comprise component (E).

If the masterbatch (M) is intended to comprise a component (B), at least one catalyst, and/or a component (C), at least one activator, it is preferable that these are likewise introduced into the extruder with component (A).

Component (B) and component (C) can be introduced into the extruder either with the first portion of component (A) or else with the second portion of component (A). However, it is preferable in the invention that the introduction of component (B) into the extruder is separate from introduction of component (C). It is therefore preferable that by way of example component (B) is introduced into the extruder with the first portion of component (A), and that component (C) is introduced into the extruder with the second portion of component (A). Equally, it is possible to introduce component (C) into the extruder with the first portion of component (A), and to introduce component (B) into the extruder with the second portion of component (A).

Masterbatch (M)

In the invention, the masterbatch (M) obtained by the process of the invention comprises components (A)—at least one lactam and (D)—at least one fiber material.

By way of example, the masterbatch (M) comprises from 1 to 90% by weight of component (D), preferably from 15 to 75% by weight, and with particular preference from 25 to 50% by weight, based in each case on the total weight of the masterbatch (M).

The present invention therefore also provides a process in which the masterbatch (M) comprises from 1 to 90% by weight of component (D), based on the total weight of the masterbatch (M).

In another embodiment, the masterbatch (M) comprises from 10 to 99% by weight of component (A) and from 1 to 90% by weight of component (D), based in each case on the sum of the percentages by weight of components (A) and (D), preferably based on the total weight of the masterbatch (M).

It is preferable that the masterbatch (M) comprises from 25 to 85% by weight of component (A) and from 15 to 75% by weight of component (D), based in each case on the sum of the percentages by weight of components (A) and (D), preferably based on the total weight of the masterbatch (M).

It is particularly preferable that the masterbatch (M) comprises from 50 to 75% by weight of component (A) and from 25 to 50% by weight of component (D), based in each case on the sum of the percentages by weight of components (A) and (D), preferably based on the total weight of the masterbatch (M).

In a preferred embodiment, the masterbatch (M) also comprises a component (B)—at least one catalyst. Component (B) is subject to the descriptions and preferences below.

The masterbatch (M) comprises by way of example from 1 to 20% by weight of component (B), preferably from 2 to 10% by weight of component (B), and particularly preferably from 3 to 6% by weight of component (B), based in each case on the total weight of the masterbatch (M).

In another preferred embodiment, the masterbatch (M) comprises no component (B).

In another preferred embodiment, the masterbatch (M) also comprises a component (C)—at least one activator. Component (C) is correspondingly subject to the descriptions and preferences provided at a later stage below.

The masterbatch (M) can by way of example comprise from 0.5 to 10% by weight, preferably from 1 to 5% by weight, and with particular preference from 1.5 to 3% by weight, of component (C), based on the total weight of the masterbatch (M).

In another preferred embodiment, the masterbatch (M) comprises no component (C).

It is in particular preferable in the invention that the masterbatch (M) comprises either component (B) or component (C). If the masterbatch (M) comprises component (B), it is therefore preferable that it comprises no component (C).

If the masterbatch comprises component (C), it is therefore preferable that it comprises no component (B).

In a preferred embodiment, the masterbatch (M) also comprises a component (E)—at least one thickener. Thickeners per se are known to the person skilled in the art. It is preferable that component (E) is selected from the group consisting of thermoplastic polystyrenes, polysulfones, polyphenyl ethers, polybutadienes, polyisoprenes, and nanofillers.

Examples of suitable nanofillers are silicates, graphenes, and carbon nanotubes.

The present invention therefore also provides a process in which the masterbatch (M) also comprises component (E), at least one thickener, where component (E) is selected from the group consisting of thermoplastic polystyrenes, polysulfones, polyphenyl ethers, polybutadienes, polyisoprenes, and nanofillers.

The masterbatch (M) comprises by way of example from 0.1 to 50% by weight, preferably from 0.5 to 30% by weight, and with particular preference from 1 to 20% by weight, of component (E), based on the total weight of the masterbatch (M).

The masterbatch (M) can moreover comprise other components.

These other components are known per se to the person skilled in the art and are by way of example stabilizers, dyes, antistatic agents, filler oils, surface-improvers, desiccants, mold-release agents, other release agents, antioxidants, light stabilizers, PVC stabilizers, lubricants, flame retardants, blowing agents, impact modifiers, and nucleating agents.

The masterbatch (M) comprises by way of example from 0.1 to 10% by weight, preferably from 0.2 to 7% by weight, and with particular preference from 0.3 to 5% by weight, of the other components, based on the total weight of the masterbatch (M).

The other components optionally comprised in the masterbatch, and also optionally components (B), (C), and (E), are usually likewise compounded in the extruder together with components (A) and (D) for the production of the masterbatch (M).

The sum of the percentages by weight of components (A) and (D) comprised in the masterbatch (M) is usually 100%. It is self-evident that when the masterbatch (M) comprises other components, and also optionally components (B), (C), and/or (E), the sum of the percentages by weight of components (A) and (D), and also of the other components optionally comprised and, where appropriate, of components (B), (C), and (E), is usually 100%.

The present invention moreover provides the masterbatch (M) obtainable by the process of the invention.

The above descriptions and preferences relating to the process of the invention apply correspondingly to the masterbatch (M) obtainable by the process of the invention.

Components (A) and (D), and also components (B) and (C), optionally comprised in the masterbatch (M) are explained in more detail below.

Component (A): Lactam

Component (A) in the invention is at least one lactam.

The terms “component (A)” and “at least one lactam” are used as synonyms in the present invention and therefore have the same meaning.

“Lactam” in the invention means cyclic amides having from 4 to 12 carbon atoms in the ring, preferably from 6 to 12 carbon atoms.

The present invention therefore also provides a process in which component (A) comprises at least one lactam having from 4 to 12 carbon atoms.

Examples of suitable lactams are selected from the group consisting of 4-aminobutanolactam (γ-lactam; γ-butyrolactam; pyrrolidone), 5-aminopentanolactam (δ-lactam; δ-valerolactam; piperidone), 6-aminohexanolactam (ε-lactam; ε-caprolactam), 7-aminoheptanolactam (ζ-lactam; ζ-heptanolactam; enantholactam), 8-aminooctanolactam (η-lactam; η-octanolactam; caprylolactam), 9-nonanolactam (θ-lactam; θ-nonanolactam), 10-decanolactam (ω-decanolactam; capric lactam), 11-undecanolactam (ω-undecanolactam), and 12-dodecanolactam (ω-dodecanolactam; laurolactam).

The present invention therefore also provides a process in which component (A) is selected from the group consisting of pyrrolidone, piperidone, ε-caprolactam, enantholactam, caprylolactam, capric lactam and laurolactam.

The lactams can be unsubstituted or can be at least monosubstituted. If at least monosubstituted lactams are used, these can bear, at the ring carbon atoms, one, two, or more substituents selected mutually independently from the group consisting of C₁- to C₁₀-alkyl, C₅- to C₆-cycloalkyl, and C₅- to C₁₀-aryl.

It is preferable that component (A) is unsubstituted.

Examples of suitable C₁- to C₁₀-alkyl substituents are methyl, ethyl, propyl, isopropyl, n-butyl, sec-butyl, and tert-butyl. An example of a suitable C₅- to C₆-cycloalkyl substituent is cyclohexyl. Preferred C₅- to C₁₀-aryl substituents are phenyl and anthranyl.

It is particularly preferable to use unsubstituted lactams, preference being given here to 12-dodecanolactam (ω-dodecanolactam) and ε-lactam (ε-caprolactam). Most preference is given to ε-lactam (ε-caprolactam).

ε-Caprolactam is the cyclic amide of caproic acid. It is also called 6-aminohexanolactam, 6-hexanolactam or caprolactam. Its IUPAC name is “Acepan-2-one”. The CAS number of caprolactam is 105-60-2, and its molecular formula is C₆H₁₁NO. Processes for the production of caprolactam are known to the person skilled in the art.

Component (B): Catalyst

Component (B) in the invention is at least one catalyst.

The terms “component (B)” and “at least one catalyst” are used as synonyms in the present invention, and therefore have the same meaning.

The at least one catalyst is preferably a catalyst for the anionic polymerization of a lactam. The at least one catalyst therefore preferably allows the formation of lactam anions. The at least one catalyst is therefore capable of forming lactamates by removing the nitrogen-bonded proton of the at least one lactam (component (A)).

Lactam anions per se can equally function as the at least one catalyst. The at least one catalyst can also be called initiator.

Suitable components (B) are known per se to the person skilled in the art, and are described by way of example in “Polyamide. Kunststoff-Handbuch” [Polyamides. Plastics Handbook], Carl-Hanser-Verlag 1998.

It is preferable that component (B) is selected from the group consisting of alkali metal lactamates, alkaline earth metal lactamates, alkali metals, alkaline earth metals, alkali metal hydrides, alkaline earth metal hydrides, alkali metal hydroxides, alkaline earth metal hydroxides, alkali metal alcoholates, alkaline earth metal alcoholates, alkali metal amides, alkaline earth metal amides, alkali metal oxides, alkaline earth metal oxides, and organometallic compounds.

The present invention therefore also provides a process in which component (B) is selected from the group consisting of alkali metal lactamates, alkaline earth metal lactamates, alkali metals, alkaline earth metals, alkali metal hydrides, alkaline earth metal hydrides, alkali metal hydroxides, alkaline earth metal hydroxides, alkali metal alcoholates, alkaline earth metal alcoholates, alkali metal amides, alkaline earth metal amides, alkali metal oxides, alkaline earth metal oxides, and organometallic compounds.

It is particularly preferable that component (B) is selected from alkali metal lactamates and alkaline earth metal lactamates.

Alkali metal lactamates are known per se to the person skilled in the art. Examples of suitable alkali metal lactamates are sodium caprolactamate and potassium caprolactamate.

Examples of suitable alkaline earth metal lactamates are magnesium bromide caprolactamate, magnesium chloride caprolactamate, and magnesium biscaprolactamate. Examples of suitable alkali metals are sodium and potassium, and examples of suitable alkaline earth metals are magnesium and calcium. Examples of suitable alkali metal hydrides are sodium hydride and potassium hydride, and suitable alkali metal hydroxides are sodium hydroxide and potassium hydroxide. Examples of suitable alkali metal alcoholates are sodium methanolate, sodium ethanolate, sodium propanolate, sodium butanolate, potassium methanolate, potassium ethanolate, potassium propanolate, and potassium butanolate.

In another embodiment that is in particular preferred, component (B) is selected from the group consisting of sodium hydride, sodium, sodium caprolactamate, and a solution of sodium caprolactamate in caprolactam. Particular preference is given to sodium caprolactamate and/or a solution of sodium caprolactamate in caprolactam (for example Brüggolen C10, from 17 to 19% by weight of sodium caprolactamate and caprolactam). The at least one catalyst can be used in the form of solid or in solution. It is preferable that the at least one catalyst is used in the form of solid. It is in particular preferable that the catalyst is added to a caprolactam melt in which it can be dissolved.

It is clear to the person skilled in the art that if component (B) is by way of example an alkali metal this reacts on contact with the at least one lactam (component (A)) and thus forms an alkali metal lactamate.

Component (C): Activator

Component (C) in the invention is at least one activator.

For the purposes of the present invention, the terms “component (C)” and “at least one activator” are used as synonyms, and therefore have the same meaning.

Any activator known to the person skilled in the art that is suitable for activating the anionic polymerization of the at least one lactam (component (A)) is suitable as the at least one activator. It is preferable that the at least one activator is selected from the group consisting of N-substituted lactams, diisocyanates, polyisocyanates, allophanates, and diacyl halides; it is particularly preferable that the at least one activator is selected from the group consisting of N-substituted lactams.

The present invention therefore also provides a process in which component (C) is selected from N-substituted lactams, diisocyanates, polyisocyanates, allophanates, and diacyl halides.

It is preferable that the N-substituted lactams have electrophilic N-substitution. Examples of suitable lactams having electrophilic N-substitution are acyllactams, for example N-acetylcaprolactam, and precursors of these which, together with the at least one lactam (component (A)), form an activated lactam in situ. An example of another suitable N-substituted lactam is a capped diisocyanate.

Diisocyanates that can be used are not only aliphatic diisocyanates but also aromatic diisocyanates. Among the aliphatic diisocyanates are by way of example butylene diisocyanate, hexamethylene diisocyanate, octamethylene diisocyanate, decamethylene diisocyanate, undecamethylene diisocyanate, dodecamethylene diisocyanate, 4,4′-methylenebis(cyclohexyl isocyanate), and isophorone diisocyanate. Examples of aromatic diisocyanates are tolyl diisocyanate and 4,4′-methylenebis(phenyl) isocyanate. Examples of polyisocyanates are isocyanates derived from hexamethylene diisocyanate (Basonat HI 100/BASF SE). Examples of suitable allophanates are ethyl allophanates.

Suitable diacyl halides are not only aliphatic diacyl halides but also aromatic diacyl halides. Suitable aliphatic diacyl halides are compounds such as butylenedioyl chloride, butylenedioyl bromide, hexamethylenedioyl chloride, hexamethylenedioyl bromide, octamethylenedioyl chloride, octamethylenedioyl bromide, decamethylenedioyl chloride, decamethylenedioyl bromide, dodecamethylenedioyl chloride, dodecamethylenedioyl bromide, 4,4′-methylenebis(cyclohexyloyl chloride), 4,4′-methylenebis(cyclohexyloyl bromide), isophoronedioyl chloride, and isophoronedioyl bromide; suitable aromatic diacyl halides are compounds such as tolylmethylenedioyl chloride, tolylmethylenedioyl bromide, 4,4′-methylenebis(phenyloyl chloride), 4,4′-methylenebis(phenyloyl bromide).

In a preferred embodiment, component (C) is selected from the group consisting of hexamethylene diisocyanate, isophorone diisocyanate, hexamethylenedioyl bromide, hexamethylenedioyl chloride, and mixtures of these; it is particularly preferable to use hexamethylene diisocyanate.

The at least one activator can be used in solution. In particular, the at least one activator can be dissolved in caprolactam.

An example of another product suitable as at least one activator is Bruggolen® C20, 80% caprolactam-blocked hexamethylene 1,6-diisocyanate in caprolactam from Brüggemann, DE.

Component (D): Fiber Material

Component (D) in the invention is at least one fiber material.

For the purposes of the present invention, the terms “component (D)” and “at least one fiber material” are used as synonyms, and therefore have the same meaning.

Any of the fiber materials known to the person skilled in the art are suitable as the at least one fiber material. It is preferable that component (D) is selected from the group of inorganic fiber materials, organic fiber materials, and natural fiber materials.

Examples of inorganic fiber materials are boron fiber materials, glassfiber materials, carbon fiber materials, silica fiber materials, ceramic fiber materials, and basalt fiber materials.

Examples of organic fiber materials are aramid fiber materials, poly(p-phenylene-2,6-benzobisoxazole) fiber materials, polyester fiber materials, nylon fiber materials, and polyethylene fiber materials.

Examples of natural fiber materials are wood fiber materials, flax fiber materials, hemp fiber materials, and sisal fiber materials.

It is preferable that component (D) is selected from the group consisting of glassfiber materials, carbon fiber materials, aramid fiber materials, poly(p-phenylene-2,6-benzobisoxazole) fiber materials, boron fiber materials, metal fiber materials, and potassium titanate fiber materials. It is in particular preferable that component (D) is a glassfiber material.

The present invention therefore also provides a process in which component (D) is selected from the group consisting of glassfiber materials, carbon fiber materials, aramid fiber materials, poly(p-phenylene-2,6-benzobisoxazole) fiber materials, boron fiber materials, metal fiber materials, and potassium titanate fiber materials.

The at least one fiber material can be used in any of the forms known to the person skilled in the art. The at least one fiber material can by way of example be used in the form of textile sheet, in the form of individual fiber, or in the form of fiber bundle.

Textile sheets are known to the person skilled in the art. The term textile sheets is used by way of example for woven fabrics, knitted fabrics, laid scrims, and nonwoven fabrics. The term fiber bundle is used by way of example for rovings, chopped glass fibers, and prepregs. It is preferable that component (D) is a fiber bundle.

Preferred fiber bundles are composed by way of example of from 100 to 100 000 individual fibers, preferably from 1000 to 70 000 individual fibers, and with particular preference from 2000 to 50 000 individual fibers.

The linear density of the fiber bundles is by way of example in the range from 50 to 10 000 tex (1 tex=1 g of fiber per 1000 m), preferably in the range from 500 to 8000 tex, and with particular preference in the range from 800 to 6000 tex.

It is preferable in the process of the invention that when component (D) is introduced into the extruder it is in a form selected from the group consisting of rovings, chopped glass fibers, ground glass fibers, and prepregs.

The present invention therefore also provides a process in which, before the compounding of components (A) and (D), when component (D) is introduced into the extruder it is in a form selected from the group consisting of rovings, chopped glass fibers, ground glass fibers, and prepregs.

It is particularly preferable that when component (D) is introduced into the extruder in the process of the invention it is in a form selected from the group consisting of rovings, chopped glass fibers, and prepregs.

The present invention therefore also provides a process in which, before the compounding of components (A) and (D), when component (D) is introduced into the extruder it is in a form selected from the group consisting of rovings, chopped glass fibers, and prepregs.

In an embodiment to which particular preference is given, the production of the masterbatch (M) comprises the following steps:
a) introduction of component (A) into the extruder,
b) addition of component (D) in a form selected from the group consisting of rovings, chopped glass fibers, ground glass fibers, and prepregs, preferably in a form selected from the group consisting of rovings, chopped glass fibers, and prepregs, to component (A) in the extruder, and
c) compounding of components (A) and (D) in the extruder to give the masterbatch (M).

The present invention therefore also provides a process in which the production of the masterbatch (M) comprises the following steps:
a) introduction of component (A) into the extruder,
b) addition of component (D) in a form selected from the group consisting of rovings, chopped glass fibers, ground glass fibers, and prepregs to component (A) in the extruder, and
c) compounding of components (A) and (D) in the extruder to give the masterbatch (M).

In another embodiment to which preference is in particular given, the production of the masterbatch (M) comprises the following steps:
a) introduction of a first portion of component (A) into the extruder,
b) addition of component (D) in a form selected from the group consisting of rovings, chopped glass fibers, ground glass fibers, and prepregs, preferably in a form selected from the group consisting of rovings, chopped glass fibers, and prepregs, to the first portion of component (A) in the extruder,
c) compounding of component (D) and of the first portion of component (A) in the extruder to give a first mixture (M1) which comprises component (D) and the first portion of component (A),
d) addition of a second portion of component (A) to the first mixture (M1) in the extruder, and
e) compounding of the first mixture (M1) and of the second portion of component (A) in the extruder to give the masterbatch (M).

The first portion of component (A) and the second portion of component (A) are correspondingly subject to the descriptions and preferences above relating to the first portion of component (A) and to the second portion of component (A).

In another embodiment to which preference is in particular given, the masterbatch (M) also comprises a component (E), at least one thickener. The production of the masterbatch (M) then preferably comprises the following steps:
a) introduction of component (E), at least one thickener, and of a first portion of component (A) into the extruder,
b) addition of component (D) in a form selected from the group consisting of rovings, chopped glass fibers, ground glass fibers, and prepregs, preferably in a form selected from the group consisting of rovings, chopped glass fibers, and prepregs, to component (E) and the first portion of component (A) in the extruder,
c) compounding of component (E), component (D), and of the first portion of component (A) in the extruder to give a first mixture (M1) which comprises components (E) and (D), and also the first portion of component (A),
d) addition of a second portion of component (A) to the first mixture (M1) in the extruder, and
e) compounding of the first mixture (M1) and of the second portion of component (A) in the extruder to give the masterbatch (M) which also comprises component (E).

The first portion of component (A) and the second portion of component (A) are correspondingly subject to the descriptions and preferences above relating to the first portion of component (A) and to the second portion of component (A).

During the compounding of components (A) and (D) in the extruder, component (D) is usually comminuted. “Comminution” means for the purposes of the present invention shortening of component (D), in particular of the fiber bundles preferably used as component (D). The fiber bundles preferably used as component (D) moreover disintegrate. This means that the fiber bundles are divided and then take the form of individual fibers. The masterbatch (M) therefore preferably comprises individual fibers as component (D). With particular preference, the form in which the masterbatch (M) comprises the fiber bundles which are introduced into the extruder, and which are preferably used as component (D), is that of individual fibers.

By way of example, component (D) comprised in the masterbatch (M) takes the form of individual fiber of length in the range from 10 to 1000 μm, preferably in the range from 20 to 500 μm, and with particular preference in the range from 30 to 300 μm.

The present invention therefore also provides a process in which component (D) takes the form of individual fiber of length in the range from 10 to 1000 μm.

Without any intention of resultant restriction of the invention, it is believed that component (D) is in particular comminuted in the kneading zones of the extruder.

Polymerizable Two-Component System (pS)

The polymerizable two-component system (pS) of the invention comprises, separately from one another,
i) a first system component (sK1) which comprises the masterbatch (M) produced in the invention and, as additional component, either (B)—at least one catalyst or (C)—at least one activator, and
ii) a second system component (sK2) which comprises components (A)—at least one lactam and either (B)—at least one catalyst or (C)—at least one activator,

where the polymerizable two-component system (pS) comprises components (B) and (C).

The present invention therefore also provides a polymerizable two-component system (pS) which comprises, separately from one another,
i) a first system component (sK1) which comprises the masterbatch (M) produced in the invention and, as additional component, either
   (B) at least one catalyst or
   (C) at least one activator,
   and
ii) a second system component (sK2) which comprises the following components:
   (A) at least one lactam and
   either
   (B) at least one catalyst or
   (C) at least one activator,

where the polymerizable two-component system (pS) comprises components (B) and (C).

The first system component (sK1) can moreover comprise component (A), at least one lactam. Equally, it is possible that the second system component (sK2) also comprises the masterbatch (M).

The present invention therefore also provides a polymerizable two-component system (pS) which comprises, separately from one another,
i) a first system component (sK1) which comprises the masterbatch (M) produced in the invention, component (A)—at least one lactam and, as additional component, either
   (B) at least one catalyst or
   (C) at least one activator,
   and
ii) a second system component (sK2) which comprises components
   (A) at least one lactam and
   either
   (B) at least one catalyst or
   (C) at least one activator,

where the polymerizable two-component system (pS) comprises components (B) and (C).

The present invention moreover provides a polymerizable two-component system (pS) which comprises, separately from one another,
i) a first system component (sK1) which comprises the masterbatch (M) produced in the invention and, as additional component, either
   (B) at least one catalyst or
   (C) at least one activator,
   and
ii) a second system component (sK2) which comprises the masterbatch (M) and components
   (A) at least one lactam and
   either
   (B) at least one catalyst or
   (C) at least one activator,

where the polymerizable two-component system (pS) comprises components (B) and (C).

The present invention moreover provides a polymerizable two-component system (pS) which comprises, separately from one another,
i) a first system component (sK1) which comprises the masterbatch (M) produced in the invention, component (A)—at least one lactam and, as additional component, either
   (B) at least one catalyst or
   (C) at least one activator,
   and
ii) a second system component (sK2) which comprises the masterbatch (M) and components
   (A) at least one lactam and
   either
   (B) at least one catalyst or
   (C) at least one activator,

where the polymerizable two-component system (pS) comprises components (B) and (C).

In another embodiment, the second system component (sK2) comprises the masterbatch (M) and either component (B) or component (C). In this embodiment, it is possible that the second system component (sK2) comprises no component (A).

The present invention therefore moreover provides a polymerizable two-component system (pS) which comprises, separately from one another,
i) a first system component (sK1) which comprises the masterbatch (M) produced in the invention and, as additional component, either
   (B) at least one catalyst or
   (C) at least one activator,
   and
ii) a second system component (sK2) which comprises the masterbatch (M) produced in the invention and, as additional component,
   either
   (B) at least one catalyst or
   (C) at least one activator,

where the polymerizable two-component system (pS) comprises components (B) and (C).

Components (A), (B), and (C) comprised, where appropriate, in the first system component (sK1) and in the second system component (sK2) are correspondingly subject to the above descriptions and preferences relating to components (A), (B) and (C).

“Separately from one another” means for the purposes of the present invention that the first system component (sK1) and the second system component (sK2) have spatial separation from one another. This means that the first system component (sK1) and the second system component (sK2) can by way of example be present in two separate containers. Equally, it is possible that the first system component (sK1) and the second system component (sK2) are present together in the same container, but have spatial separation from one another by way of example by a wall.

The polymerizable two-component system (pS) comprises by way of example from 1 to 99% by weight of the first system component (sK1) and from 1 to 99% by weight of the second system component (sK2), based on the total weight of the polymerizable two-component system (pS).

The polymerizable two-component system (pS) comprises preferably from 4 to 98% by weight of the first system component (sK1) and from 2 to 96% by weight of the second system component (sK2), in each case based on the total weight of the polymerizable two-component system (pS).

The polymerizable two-component system (pS) comprises with particular preference from 45 to 55% by weight of the first system component (sK1) and from 45 to 55% by weight of the second system component (sK2), in each case based on the total weight of the polymerizable two-component system (pS).

The first system component (sK1) in the invention comprises the masterbatch (M) produced in the invention and, as additional component, either (B)—at least one catalyst or (C)—at least one activator.

It is preferable here in the invention that the masterbatch (M) comprises no component (B)—at least one catalyst—and no component (C)—at least one activator. In particular, it is preferable that the masterbatch (M) in this embodiment is composed of component (A), component (D), and also optionally component (E).

The first system component (sK1) comprises, as additional component, either (B)—at least one catalyst or (C)—at least one activator. This means that the first system component (sK1) in one embodiment of the present invention comprises component (B) and no component (C).

In another embodiment this means that the first system component (sK1) comprises component (C) and no component (B).

The first system component (sK1) can comprise the masterbatch (M) and either the additional component (B) or the additional component (C), and also optionally component (A) in any desired quantities.

The second system component (sK2) comprises components (A) and either (B) or (C). This means that the second system component (sK2) by way of example comprises component (A) and component (B), and no component (C).

In another embodiment, the second system component (sK2) comprises component (A) and component (C) and no component (B).

In one embodiment, the second system component (sK2) is therefore composed of component (A) and of component (B).

In another embodiment, the second system component (sK2) is composed of component (A) and of component (C).

The second system component (sK2) can comprise component (A) and either component (B) or component (C), and also optionally the masterbatch (M) in any desired quantities.

It is preferable that the first system component (sK1) and the second system component (sK2) comprise components (A), (B) and (C), and also the masterbatch (M) in quantities such that the composition of the polymerizable mixture (pM) obtained in a preferred embodiment of the invention after mixing of the first system component (sK1) and of the second system component (sK2) is that described at a later stage below.

It is self-evident that when the first system component (sK1) comprises component (B) the second system component (sK2) comprises component (C).

When, in contrast, the first system component (sK1) comprises component (C), the second system component (sK2) then comprises component (B).

Polyamide (P)

The polymerizable two-component system (pS) of the invention can be used for the production of a polyamide (P).

The polyamide (P) can be produced from the polymerizable two-component system (pS) by any of the methods known to the person skilled in the art.

The process for the production of the polyamide (P) using the polymerizable two-component system (pS) preferably comprises the following steps:
a) provision of the polymerizable two-component system (pS) of the invention,
b) mixing of the first system component (sK1) of the polymerizable two-component system (pS) and of the second system component (sK2) of the polymerizable two-component system (pS) to give a polymerizable mixture (pM),
c) polymerization of the polymerizable mixture (pM) obtained in step b) to give the polyamide (P).

The present invention therefore also provides a process comprising the following steps:
a) provision of a polymerizable two-component system (pS) of the invention,
b) mixing of the first system component (sK1) and of the second system component (sK2) to give a polymerizable mixture (pM),
c) polymerization of the polymerizable mixture (pM) obtained in step b) to give the polyamide (P).

The polymerizable two-component system (pS) can be provided in step a) by any of the methods known to the person skilled in the art.

Any of the methods known to the person skilled in the art is suitable for the mixing of the first system component (sK1) and of the second system component (sK2) in step b). By way of example, the first system component (sK1) and the second system component (sK2) can be mixed while they are injected into a mold.

The first system component (sK1) and the second system component (sK2) can be mixed directly in the mold to give the polymerizable mixture (pM). Equally it is possible, and preferred in the invention, that the first system component (sK1) and the second system component (sK2) are mixed in a suitable mixing device to give the polymerizable mixture (pM), which is then afterward introduced into a mold. It is preferable that the polymerizable mixture (pM) is produced and afterward introduced into a mold. These mixing devices are known per se to the person skilled in the art and are by way of example static and/or dynamic mixers.

The polymerizable mixture (pM) obtained in step b) therefore comprises the masterbatch (M), and also component (B) and component (C). In other words, the polymerizable mixture (pM) comprises components (A)—at least one lactam, (B)—at least one catalyst, (C)—at least one activator, and (D)—at least one fiber material.

By way of example, the polymerizable mixture (pM) comprises from 28.5 to 90% by weight of component (A), from 1 to 20% by weight of component (B), from 0.5 to 10% by weight of component (C), and from 8.5 to 70% by weight of component (D), based in each case on the sum of the percentages by weight of components (A), (B), (C), and (D), preferably based on the total weight of the polymerizable mixture (pM).

It is preferable that the polymerizable mixture (pM) comprises from 37 to 80% by weight of component (A), from 2 to 10% by weight of component (B), from 1 to 5% by weight of component (C), and from 17 to 60% by weight of component (D), based in each case on the sum of the percentages by weight of components (A), (B), (C), and (D), preferably based on the total weight of the polymerizable mixture (pM).

It is in particular preferable that the polymerizable mixture (pM) comprises from 45.5 to 70% by weight of component (A), from 3 to 6% by weight of component (B), from 1.5 to 3% by weight of component (C), and from 25.5 to 50% by weight of component (D), based in each case on the sum of the percentages by weight of components (A), (B), (C), and (D), preferably based on the total weight of the polymerizable mixture (pM).

The polymerizable mixture (pM) comprises component (D) dispersed in components (A), (B), (C), and also optionally (E). Component (D) is therefore also called “disperse phase”, and components (A), (B), (C), and also optionally (E) are also called “continuous phase”.

The viscosity of the continuous phase, i.e. components (A), (B), (C), and also optionally (E) comprised in the polymerizable mixture (pM), without component (D), is by way of example in the range from 2 to 1000 mPas, preferably in the range from 5 to 500 mPas, and with particular preference in the range from 10 to 300 mPas, measured with a shear-stress-controlled rotary viscometer at shear rate 100 s⁻¹ and at temperature 100° C.

The polymerization of the polymerizable mixture (pM) in step c) is usually initiated by heating the polymerizable mixture (pM) to a temperature above the melting point of the at least one lactam. It is preferable to heat the polymerizable mixture (pM) to a temperature below the melting point of the polyamide (P).

It is self-evident that the melting point of the at least one lactam is below the melting point of the polyamide (P).

By way of example, for the polymerization in step c) the polymerizable mixture (pM) is heated to a temperature in the range from 130 to 180° C., preferably in the range from 135 to 170° C., and with particular preference in the range from 140 to 160° C.

The at least one lactam comprised in the polymerizable mixture (pM) polymerizes here, and the polyamide (P) is obtained.

The present invention therefore also provides a polyamide (P) obtainable by the process described for the production of a polyamide (P).

For the polymerization it is possible by way of example that the polymerizable mixture (pM) is introduced into a mold. In that case, a molding is obtained from the polyamide (P) during the polymerization of the polymerizable mixture (pM).

The present invention therefore also provides a molding made of the polyamide (P) of the invention.

The present invention moreover provides the use, for the production of the polyamide (P), of the masterbatch (M) produced in the invention.

The invention is explained in more detail below by examples, but is not restricted thereto.

### COMPARATIVE EXAMPLE 1

An extruder with three sections was used. The first section (I) comprised a zone with prevailing temperature 35° C., the second section (II) comprised 4 zones with the following temperatures: 170° C., 170° C., 130° C., and 90° C. The third section (III) comprised 8 zones with the following temperatures: 70° C., 60° C., 50° C., 50° C., 40° C., 40° C., 40° C., and 40° C. The respective temperatures are based on the jacket temperatures of the extruder.

200 g of thickener (Styroflex, 2G66 from Styrolution) were mixed with 5000 g of caprolactam. This mixture was introduced into the first zone of the first section (I) (35° C.) of the extruder. In the second zone (first zone of the second section (II)), 1 kg of glass fiber was metered into the system at 1.5 kg/h. In the sixth zone (first zone of the third section (III), 70° C.), 1.5 kg of caprolactam per hour were added. The extrusion product obtained was inhomogeneous and comprised clumps.

### INVENTIVE EXAMPLE 2

An extruder with three sections was used. The first section (I) comprised a zone with prevailing temperature 35° C., the second section (II) comprised 4 zones with the following temperatures: 170° C., 170° C., 150° C., and 120° C. The third section (III) comprised 8 zones with the following temperatures: 100° C., 80° C., 60° C., 50° C., 40° C., 40° C., 40° C., and 40° C. The respective temperatures are based on the jacket temperatures of the extruder.

200 g of thickener (Styroflex, 2G66 from Styrolution) were mixed with 5000 g of caprolactam. This mixture was introduced into the first zone of the first section (I) (35° C.) of the extruder. In the second zone (first zone of the second section (II), 170° C.), 1 kg of glass fiber was metered into the system at 1.5 kg/h. In the sixth zone (first zone of the third section (III), 70° C.), 1.5 kg of caprolactam per hour were added. The extrusion product obtained was homogeneous and comprised no clumps.

It can be seen that the quality of the product depends on the jacket temperature of the extruder, and that the jacket temperature in particular influences the homogeneity of the product.

1. A process for the production of a masterbatch (M) that includes the following components:
(A) at least one lactam, and
(D) at least one fiber material,
wherein the process comprises compounding the components (A) and (D) in an extruder with a shear rate of at least 500 s⁻¹, wherein the extruder includes at least the following sections:
(I) a first section,
(II) a second section, and
(III) a third section,
wherein the first section (I) has a first temperature (T1), the second section (II) has a second temperature (T2), and the third section (III) has a third temperature (T3), and wherein the second temperature (T2) is in a range from 105° C. to 220° C.

2. (canceled)

3. The process according to claim 1, wherein the first temperature (T1) is in a range from 20° C. to 70° C.

4. The process according to claim 1, wherein the second section (II) of the extruder includes from 2 to 10 kneading zones and from 1 to 10 conveying zones.

5. The process according to claim 1, wherein the masterbatch (M) comprises from 1 to 90% by weight of the component (D), based on a total weight of the masterbatch (M).

6. The process according to claim 1, wherein the component (D) is selected from the group consisting of glassfiber materials, carbon fiber materials, aramid fiber materials, poly(p-phenylene-2,6-benzobisoxazole) fiber materials, boron fiber materials, metal fiber materials, and potassium titanate fiber materials.

7. The process according to claim 1, wherein the component (D) is in a form of an individual fiber of length in a range from 10 μm to 1000 μm.

8. The process according to claim 1, wherein the masterbatch (M) also comprises a component (E) including at least one thickener, wherein the component (E) is selected from the group consisting of thermoplastic polystyrenes, polysulfones, polyphenyl ethers, polybutadienes, polyisoprenes, and nanofillers.

9. The process according to claim 1, further comprising:
a) introducing the component (A) into the extruder,
b) adding the component (D) in a form selected from the group consisting of rovings, chopped glass fibers, ground glass fibers, and prepregs to the component (A) in the extruder, and
c) said compounding the components (A) and (D) in the extruder to produce the masterbatch (M).

10. A masterbatch (M) obtainable by a process according to claim 1.

11. A polymerizable two-component system (pS) that comprises, separately from one another:
i) a first system component (sK1) that comprises a masterbatch (M) in accordance with claim 10 and one of:
(B) at least one catalyst, and
(C) at least one activator,
and
ii) a second system component (sK2) that comprises the following components:
(A) at least one lactam, and
the other of:
(B) at least one catalyst, and
(C) at least one activator,
such that the polymerizable two-component system (pS) comprises the components (B) and (C).

12. A process for the production of a polyamide (P), the process comprising the following steps:
a) providing a polymerizable two-component system (pS) according to claim 11,
b) mixing the first system component (sK1) and the second system component (sK2) to give a polymerizable mixture (pM),
c) polymerizing the polymerizable mixture (pM) to produce the polyamide (P).

13. A process for the production of a polyamide (P), the process comprising using the masterbatch (M) according to claim 10 to produce a polyamide (P).

14. A polyamide (P) obtainable by a process according to claim 12.

15. A molding made of the polyamide (P) according to claim 14.

16. The process according to claim 1, wherein the third temperature (T3) is in a range from 20° C. to less than 105° C.

17. The process according to claim 1, wherein the third section (III) of the extruder comprises from 1 to 5 mixing zones, from 1 to 5 kneading zones, from 2 to 10 conveying zones, and from 1 to 5 flow-restricting zones.
